(19) United States
(12) Patent Application Publication
(10) Pub. No.: US 2018/0193865 A1
(43) Pub. Date: Jul. 12, 2018

(54) CHANGING DEVICE AND COATING SYSTEM FOR COATING OBJECTS

(71) Applicant: EISENMANN SE, Boeblingen (DE)

(72) Inventors: Donald Riedeberger, Stuttgart (DE); Raphael Mack, Metzingen (DE)

(21) Appl. No.: 15/742,227

(22) PCT Filed: Jun. 14, 2016
(86) PCT No.: PCT/EP2016/063584

§ 371 Date: Jan. 5, 2018

(30) Foreign Application Priority Data
Jul. 13, 2015 (DE) 10 2015 008 845.9

(51) Int. Cl. B05B 12/14

(52) U.S. Cl. CPC B05B 12/1481; B05B 12/149; B05B 12/14

(57) ABSTRACT

A changing device for media, in particular for varnishes, having multiple connections, each of which can be connected to a reservoir for a medium. At least one docking unit is provided, having a coupling connection which is complementary to the connections and can be connected to a supply line for an applicator of a coating system. The docking unit can be moved relative to the connections by means of a positioning device. A delivery pressure device is provided, by means of which the delivery pressure, with which a medium is fed into the supply line, can be adjusted and/or supported, and/or by means of which the return pressure, with which a medium is returned from the supply line into the reservoir, can be adjusted and/or supported. A coating system with a changing device of this type is also provided.

The invention relates to a changing device for media, in particular for paints, having
a) multiple connections, each of which is able to be connected to a reservoir for a medium;
b) at least one docking unit, which comprises a coupling connection which complements the connections and is able to be connected to a supply line for an application device of a coating system;
c) a positioning device, by means of which the docking unit is able to be moved relative to the connections.

The invention also relates to a coating system for coating objects, having

a) an application device;

b) a supply system with at least one supply line, via which line a liquid medium is able to be supplied to the application device.

“Lines” are to be understood in the present case as meaning all flow paths for fluid media. Consequently, besides flexible hose lines or rigid lines, this also includes channels machined into bodies, flow chambers or even just passage openings. “A reservoir for a medium” is to be understood in the present case as meaning each material source for a medium. Here, it may be containers, such as for example a paint tank or the like, but also media-carrying lines, such as are present for example in ring line systems in a manner known per se.

Coating systems of said type are used for example in the automotive industry for coating objects such as vehicle bodies or body parts with the aid of electrostatically operating application devices. The coating material, for example a paint, is in this case discharged from the application device and exposed to an electric field in which the coating material is ionized and, due to electrostatic forces, transported to the object, which, for this purpose, is for example at ground potential. Such an application device may be for example a high-speed rotational atomizer with a rotating bell-shaped plate, from which very small paint drops are centrifuged out such that a paint mist forms.

In the delivery of paints and other liquid materials through lines, the pigging technique, in which a sliding body, referred to as a “pig”, pushes along in front of it a material volume, has become established. Here, the pig is acted upon on that side which is remote from the delivery volume by a pressurized fluid, which may be for example compressed air or also a cleaning liquid, which cleans the line behind the pig.

So-called ring lines are generally present as material sources or reservoirs for the coating material, wherein a fluidic connection between a material-carrying ring line and the piggable supply line can be established by means of the supply unit. Before the pig then forces the material in the direction toward the application device, the material is firstly forced into the system by way of the autogenous pressure which prevails in the material sources, that is to say in the ring lines.

The line path to the application device is quite long and can have a relatively small diameter, which can for example be approximately 1 mm, at least in sections. Due to this relatively small diameter, a pressure loss occurs along the line, which makes it more difficult for the material to be delivered solely by way of the autogenous pressure of the connected material source. Moreover, the autogenous pressure in the material sources is generally not constant but is subjected to irregular variations occurring for technical reasons, this also making reproducibility of the delivered volume more difficult.

During the supply to the application device, there always remains in the line system a residual volume of medium which is not applied. A major part of said volume is forced back into the associated ring line during a cleaning process, so that the medium is recovered. This can give rise to difficulties since the medium has to be forced back counter to the autogenous pressure of the associated ring line from the direction of the application device. It is the object of the invention to provide a changing device and a coating system of the type mentioned at the beginning which take account of these considerations.

Said object is achieved, in the case of a changing device of the type mentioned at the beginning, in that

d) a delivery pressure device is present, by means of which the input pressure with which a medium is fed into the supply line can be set and/or assisted, and/or by means of which the return pressure with which a medium is fed back into the reservoir from the supply line can be set and/or assisted.

As a result of the delivery pressure device which is additionally present, the medium can be fed into the supply line with a predefined and reproducible delivery pressure such that pressure variations in the material sources are now only a negligible irregularity. Furthermore, a sufficiently high delivery pressure on the medium can be built up by way of the delivery pressure device, and so it is also possible for possible pressure losses along the delivery path to the application device to be compensated. Alternatively or additionally, close to the connection of the changing device, the delivery pressure device can have the effect that, or assist in ensuring that, a medium is fed back into the reservoir, whereby a relatively high delivery pressure can be built up and thus the autogenous pressure of the associated reservoir can be effectively counteracted.

Preferably here, the delivery pressure device is carried along by the movable docking unit. In this way, it is not necessary for relatively long line paths between the coupling connection of the movable docking unit and the delivery pressure device to be formed.

The delivery pressure device is particularly advantageously a pressure cylinder with a pressure chamber which is able to be selectively connected to the coupling connection of the docking station or to the supply line by means of a valve arrangement.

Generally, the delivery pressure device can also effect or assist the removal of medium from a reservoir if the autogenous pressure in the reservoir is not sufficient to deliver the desired medium into the line system. In the case of the pressure cylinder, said cylinder is able to draw up the medium from the reservoir, as it were, like a syringe and then to force said medium into the supply line.

The coupling connection is advantageously able to be connected to the supply line directly by means of a valve arrangement. Thus, if appropriate, medium can be carried past the delivery pressure device. This can be achieved by way of the valve arrangement already mentioned, which is then correspondingly configured.

For a quick change of media, it is possible for the application device to be supplied from two supply strands. In this case, a separate changing device may be provided for each supply strand. Alternatively, it is favorable, however, if at least two docking units are present at the changing device. Thus, each supply strand can interact with one docking unit of one and the same changing device. The required installation space for such a changing device with two docking units is smaller than for two changing units with in each case one separate docking unit.

In order that different docking units are then also able to be fed from one and the same reservoir and do not impede one another, it is favorable if, for each reservoir, two connections and two docking units are present, the first docking unit of which interacts with one of the connections for each reservoir, and the second docking unit of which interacts with the other one of the connections for each reservoir.

With regard to the coating system, the above-mentioned object is achieved in that

c) the supply system comprises at least one changing device for media having some or all of the features discussed above.

For an effective delivery of the media and cleaning of the lines, preferably at least one section of the supply line is pigged.

It is favorable if the supply line is connected at that end which is remote from the changing device to a supply container from which the application device can be fed.

A particularly uniform and reproducible delivery of medium to the application device can be achieved if the supply container is a piston dosing device.

Material can be effectively changed if the supply system comprises a distributor, via which the application device can be fed from a first supply strand or a second supply strand, wherein each supply strand comprises a separate supply line, and all further, previously mentioned components are separately present at the first supply strand and at the second supply strand.

Exemplary embodiments of the invention will now be discussed in more detail below on the basis of the drawings, in which

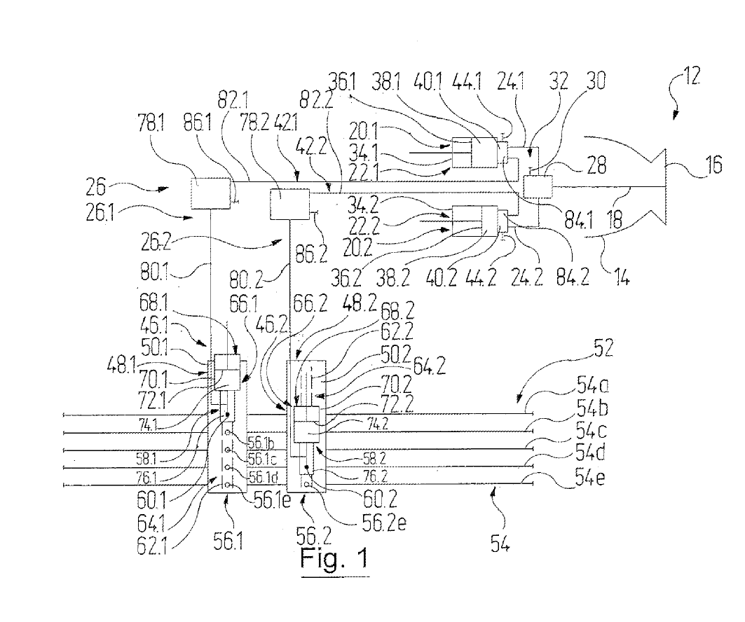

FIG. 1 schematically shows a coating system with an application device and with a supply device as per a first exemplary embodiment;

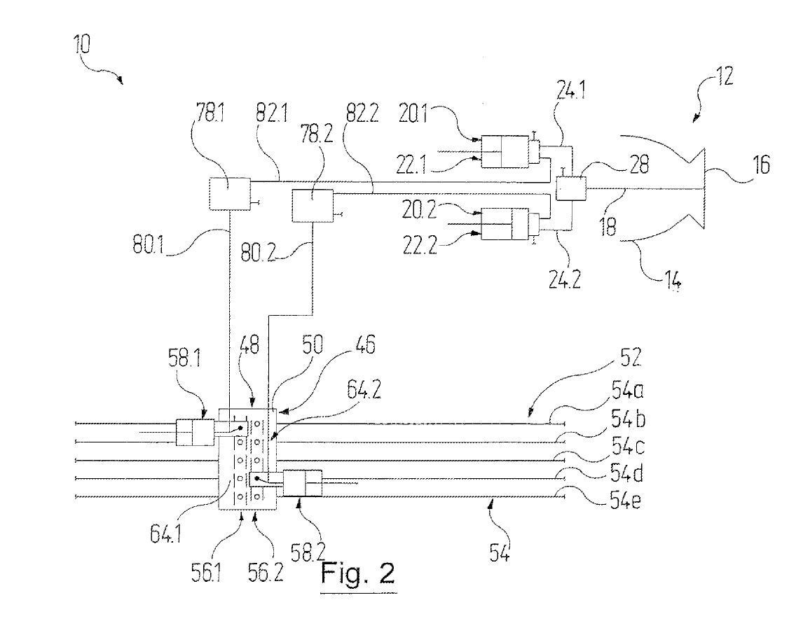

FIG. 2 schematically shows a coating system with an application device and with a supply device as per a second exemplary embodiment.

The figures schematically show a coating system 10 for coating objects, for example vehicle bodies or parts or attachments thereof.

The coating system 10 comprises an application device 12, which is shown only schematically in the present exemplary embodiment. In the present exemplary embodiments, the application device 12 is an electrostatically operating high-speed rotational atomizer 14 with a rotating bell-shaped plate 16.

The application device 12 comprises a discharge line 18, via which coating material can be discharged onto an object (not shown specifically). In the present exemplary embodiment, the discharge line 18 leads to the bell-shaped plate 16 of the high-speed rotational atomizer 14. The bell-shaped plate 16 and the discharge line 18 thus from a discharge device.

The application device 12 can be selectively fed with a liquid medium from a first supply container 20.1, in the form of a first piston dosing device 22.1, via a first feed line 24.1 of a first supply strand 26.1 or from a second supply container 20.2, in the form of a piston dosing device 22.2, via a second feed line 24.2 of a second supply strand 26.2. The first piston dosing device 22.1 and the second piston dosing device 22.2 each demonstrate just one example for a first supply container 20.1 and a second supply container 20.2, respectively, for coating material.

The two supply strands 26.1, 26.2 together form a supply system 26 and have the same structure, and for this reason, for the sake of simplicity, only the first supply strand 26.1 is further discussed below. Reference signs for identical structural parts and components bear the index “0.1” in the case of the first supply strand 26.1 and the index “0.2” in the case of the second supply strand 26.2.

The two feed lines 24.1 and 24.2 open out, at the ends which are remote from the piston dosing devices 22.1, 22.2, into a distributor 28, which is connected to the discharge line 18, and so the application device 12 is able to be selectively connected to the feed line 24.1 or to the feed line 24.2.

The distributor 28 is also connected to a cleaning line 30 of a cleaning system 32 (not shown in more detail) and is configured such that said cleaning line 30 is able to be selectively connected to the feed line 24.1, to the feed line 24.2 or to the discharge line 18. It is possible for a cleaning medium, for example a solvent, or a pressurized fluid, for example compressed air, to be supplied in a manner known per se from associated material sources to the distributor 28 by way of the cleaning line 30, wherein separate cleaning lines 30 may also be present for different media.

The piston dosing device 22.1 comprises a cylinder 34.1 in which a piston 36.1 can be moved with the aid of a piston drive (not shown specifically). With the cylinder 34.1, the piston 36.1 delimits a working chamber 38.1, which has a variable volume and is connected to the first feed line 24.1 via a valve unit 40.1. Moreover, the working chamber 38.1 is connected via the valve unit 40.1 to a supply line 42.1 and to an outlet line 44.1, the latter leading to the drain line 54e of the ring lines 52.

The supply line 42.1 is connected to a supply device 46.1 of the supply system 26, by means of which device media is able to be delivered into the supply line 42.1.

The supply device 46.1 comprises, as a supply unit, a color changing device 48.1, which is connected in a manner known per se via a connection block 50.1 having a valve arrangement (not shown specifically) to a ring line system 52 having a multiplicity of media-carrying lines 54 which each define a material source. Of such lines, the figures illustrate only two paint lines 54a, 54b, a cleaning agent line 54c, a compressed air line 54d and a drain line 54e via which a medium, such as for example solvent, or else paint which is no longer usable can be drained from the system. In practice, it is certainly possible for fifty or more media-carrying lines 54, through which mutually different paints or other media flow, to be present.

The connection block 50.1 comprises a connection 56.1 for each ring line 52, wherein each connection 56.1 bears the same letter index as the in each case associated ring line. The color changing device 48.1 also includes a movable docking unit 58.1 which can be moved on the connection block 50.1 and thereby selectively connected fluidically to in each case one connection 56.1a to 56.1e. For this purpose, the docking unit 58.1 comprises a coupling connection 60.1, which complements the connections 56.1 at the connection block 50.1 and is able to be coupled to in each case one of the connections 56.1.

Here, the docking unit 58.1 is guided by a guiding device 62.1, illustrated only by dashed lines, on the connection block 50.1 and can, by means of a coupling device 64.1, which also comprises a drive (not shown specifically), be moved along the connection block 50.1 and coupled to in each case one of the connections 56.1 and detached therefrom. The coupling device 64.1 comprises coupling means (known per se and therefore not shown specifically), which ensure a fluid-tight and detachable connection between the selected connection 56.1 at the connection block 50.1 and the coupling connection 60.1 of the docking unit 58.1. The guiding device 62.1 and the coupling device 64.1 together form a positioning device for the docking unit 58.1.

In the present exemplary embodiment, the travelling movement of the docking unit 58.1 is performed in a linear manner along the connection block 50.1 as predetermined by the arrangement of the connections 56.1. In variants (not shown specifically), it is possible, however, for the connections 56.1 of the connection block 50.1 to also be arranged distributed in a plane and/or arranged offset from one another in a direction parallel to the axis of the connections 56.1. The guiding device 62.1 and the coupling device 64.1 are designed in such a way that the docking unit 58.1 is able to perform all required movements in order to reach all required connections 56.1 and to be coupled in a fluid-tight manner thereto.

As discussed at the beginning, pressure losses occur in the supply line 42.1 due to its small cross section and/or its great length, and so the correct delivery of a medium, by way of the autogenous pressure of the ring line system, into the supply line 42.1 and the piston dosing device 22.1 connected thereto is not always ensured.

For this reason, the color changing device 48.1 comprises a delivery pressure device 66.1, by means of which the input pressure with which a medium is fed into the supply line 42.1 to the piston dosing device 22.1 can be set and/or assisted. Furthermore, the return pressure with which a medium is delivered back into the associated ring line 54 during a return process can also be set and/or assisted. In the present exemplary embodiment, said delivery pressure device 66.1 is carried along by the docking unit 58.1; in one variant (not shown specifically), however, it is also possible for the delivery pressure device 66.1 to be arranged so as to be stationary and to be connected to the docking unit 58.1 via a connecting line. However, the connecting line is at all times short in relation to the line path between the changing device 48.1 and the piston dosing device 22.1 or the application device 12.

The delivery pressure device 66.1 is in the form of a pressure cylinder 68.1 which comprises a cylinder 70.1 in which a piston 72.1 can be moved with the aid of a piston drive (not shown specifically). With the cylinder 70.1, the piston 72.1 delimits a pressure chamber 74.1, which has a variable volume. Since the pressure cylinder 68.1 has to withstand high pressures, up to for example 16 bar and higher, in practice, the cylinder 70.1 is composed of metal, in particular stainless steel, in practice.

The pressure chamber 74.1 is connected via a valve arrangement 76.1 to the coupling connection 60.1 of the docking unit 58.1 and to the supply line 42.1. The valve arrangement 76.1 may be set in such a way that, selectively, the pressure chamber 74.1 can be connected fluidically to the coupling connection 60.1, or the pressure chamber 74.1 can be connected fluidically to the supply line 42.1, or the coupling connection 60.1 can be connected fluidically to the supply line 42.1. In the latter case, the coupling connection 60.1 is thus connected directly to the supply line 42.1, with the result that a medium can be carried past the pressure cylinder 68.1, so that a corresponding bypass line formed.

Put in general terms, the coupling connection 60.1 can thus be selectively connected directly to the supply line 42.1 by means of a valve arrangement 76.1.

The supply line 42.1 may be designed partially or completely as a pigging line. In the present exemplary embodiment, a first pigging station 78.1 is arranged in the supply line 42.1 downstream of the color changing device 48.1, with the result that the supply line 42.1 is subdivided into two supply sections 80.1 and 82.1. The first supply section 80.1 extends between the docking unit 58.1 and the first pigging station 78.1, and the second supply section 82.1 extends between the first pigging station 78.1 and a second pigging station 84.1 at the piston dosing device 22.1. If the entire supply line 42.1 or the supply section 80.1 is designed as a pigging line, a pigging station is present at the color changing device 48.1.

The first pigging station 78.1 is also connected in a known manner to a working line 86.1, which is able to be closed or opened by means of a valve (not shown specifically) and via which a working medium is able to be supplied to the first pigging station 78.1 and, thereby, to the piggable section 82.1 of the supply line 41.1 or which can serve as an output line in order to drain medium from the line system. Such a working line is available at the second pigging station 84.1 by way of the cleaning line 30.

In variants (not shown specifically), it is alternatively or additionally possible for the first supply section 80.1 of the supply line 42.1 to be pigged. In this case, a pigging station is also present at the docking unit 58.1.

A pig (not shown specifically) can in any case be moved between the pigging stations 78.1 and 84.1 in both directions.

Present in the exemplary embodiment shown in FIG. 1 are two color changing devices 48.1, 48.2 with in each case separate connection blocks 50.1, 50.2 which guide in each case one docking unit 58.1 and 58.2, respectively.

FIG. 2 shows, as a second exemplary embodiment, a coating system 10 in which a single color changing device, denoted there by “48”, with a connection block 50 is present, said device comprising both docking units 58.1 and 58.2. The connection block 50 accordingly provides the connections 56.1 and 56.2 connected to the ring lines 54, the guiding devices 62.1 and 62.2 and the coupling devices 64.1 and 64.2 for both docking units 58.1, 58.2. For the sake of simplicity, not all components are provided with a reference sign in FIG. 2.

In the exemplary embodiment shown in FIG. 2, both docking units 58.1, 58.2 are arranged on the same side of the connection block 50. In one variant (not shown specifically), the docking units 58.1 and 58.2 may also be guided on different, in particular on opposite, sides of the connection block 50.

The coating system 10 then functions as follows, with only the sequences of interest here being discussed below without details being provided of additional and known processes which are necessary for example for the cleaning of line sections.

Let us assume as a starting point a working configuration of the coating system 10 in which paint is supplied to the application device 12 from the second piston dosing device 22.2 in that the piston 36.2 of the latter is moved in the direction toward the valve unit 40.2. In this case, the valve unit 40.2 blocks the supply line 42.2 and the outlet line 44.2 and opens the flow path to the distributor 28. The latter, for its part, connects the feed line 24.2 to the discharge line 18 of the application device 12 which applies the material from the second piston dosing device 22.2 to an object. The feed line 24.1 between the distributor 28 and the first piston dosing device 22.1 has been cleaned and is dry, and so an electrical insulation path is formed there.

During a color change, the docking unit 58.1 of the first color changing device 48.1 is then moved to the connection 56 of the ring line 52 carrying the paint material which is to be applied next. Suppose, for example, this is the paint line 52a. In FIG. 1, the coupling connection 60.1 of the docking unit 58.1 is correspondingly coupled to the connection 56a of the first color changing device 48.1.

The valve arrangement 76.1 is put into a loading configuration in which the coupling connection 60.1 is connected to the pressure chamber 74.1, wherein the piston 72.1 is firstly moved forward such that the pressure chamber 74.1 has the smallest possible volume. The piston 72.1 is then moved back, as a result of which the pressure chamber 74.1 fills with material from the paint line 54a.

Afterwards, the valve arrangement 76.1 of the docking unit 58.1 is put into a pressure-generation configuration such that the pressure chamber 74.1 is connected to the supply line 42.1 and, specifically, to the first supply section 80.1 thereof. The piston 36.1 of the first piston dosing device 22.1 has been pushed forward such that the working chamber 38.1 has the smallest possible volume. The piston 72.1 is then moved forward, as a result of which the paint is forced with a delivery pressure into the supply line 42.1 and, in the process, into the first and second supply section 80.1 and 82.1. The delivery pressure can be set via the piston advancing unit. In this way, the paint can be delivered with a reproducible and in particular uniform pressure to the piston dosing device 22.1 without pressure variations occurring, as can arise if the autogenous pressure in the ring line system 52 is used to deliver a paint material to one of the piston dosing devices 22.1, 22.2. Also, the pressure loss, due to the relatively small cross section in the supply lines 42.1, 42.2, along the delivery path can thus be effectively counteracted.

In the second supply section 82.1 of the first supply line 42.1, the paint is delivered further to the piston dosing device 22.1 by means of the pigging technique, as is known per se. When the paint passes to the first piston dosing device 22.1, the piston 36.1 thereof moves back such that the paint is able to flow through the valve unit 40.1 into the working chamber 38.1 of said device.

Since the delivery pressure device 66.1 serves for setting the input pressure for the feeding of the media into the supply line 42.1, it is possible for the volume of the pressure chamber 74.1 to be smaller than the volume of paint which is required for the application and which has to be held by the piston dosing device 22.1. In this case, the piston dosing device 22.1 is correspondingly filled up batch by batch in two or more steps, during which time the application with material from the second piston dosing device 22.2 can continue to be carried out.

Before it is possible to initiate the next electrostatic application process and to set the application device 12 to a high-voltage potential, it is firstly necessary for the application device 12 to be freed of the material from the second piston dosing device 22.2 and cleaned, and at the same time for the supply line 42.1 to be freed of conductive material and dried so that an electrical insulation path is built up in the supply line 42.1.

During the cleaning process, paint material is forced through the supply line 42.1 back into the ring line 52a. To this end, the paint material is firstly delivered into the pressure cylinder 68.1, for which purpose the valve arrangement 76.1 connects the supply line 42.1 to the pressure chamber 74.1 of said cylinder. When the phase boundary between the cleaning fluid and the paint material reaches the valve arrangement 76.1 of the first color changing device 48.1 from the supply line 42.1, the valve arrangement 76.1 is set in such a way that the pressure chamber 74.1 is connected to the connection 56.1a. With the aid of the piston 72.1, the paint material is then forced out of the pressure chamber 74.1 into the ring line 54a counter to the autogenous pressure of the latter. Afterwards, the docking unit 58.1 is uncoupled from the connection 56a, moved to the connection 56e of the drain line 54a, and coupled to the latter connection so that the remainder of the material can be drained from the line system.

In order to clean the pressure cylinder 68.1, said cylinder or the associated valve arrangement 76.1 can be connected to a separate cleaning agent line and/or to a separate drain line so that a cleaning process which is independent of the color cleaning device 48.1 can be carried out for the pressure cylinder 68.1.

The first supply strand 26.1 is then ready for the application of the paint material from the piston dosing device 22.1, for which purpose the valve unit 40.1 blocks the supply line 42.1 and connects the piston dosing device 22.1 to the distributor 28, the latter opening the flow path to the discharge line 18. The piston 36.1 is moved in the direction toward the valve unit 40.1, and the paint is applied.

During said application process, the second piston dosing device 22.2 of the second supply strand 26.2 can then be filled with material in the manner discussed above.

In the coating system according to FIG. 2, said processes are carried out in an analogous manner, with the docking units 58.1, 58.2 being moved on the single connection block 50 present.

In variants (not shown specifically), it is also possible for delivery pressure devices formed differently to be carried along by the docking unit 58.1, 58.2. These may be, for example, pumps or the like. Other technologies, for example bellows or diaphragms, can also be considered.

What is claimed is:

1. A changing device for media comprising:
a) multiple connections, each connection being connectable to a reservoir for a medium;
b) at least one docking unit comprising a coupling connection which complements each of the multiple connections and is able to be connected to a supply line for an application device of a coating system;
c) a positioning device, by means of which the at least one docking unit is able to be moved relative to the multiple connections;
wherein
d) a delivery pressure device is present, by means of which the input pressure with which a medium is fed into the supply line can be set and/or assisted, and/or by means of which the return pressure with which a medium is fed back into its reservoir from the supply line can be set and/or assisted.

2. The changing device as claimed in claim 1, wherein the delivery pressure device is carried along by the at least one docking unit.

3. The changing device as claimed in claim 1, wherein the delivery pressure device is a pressure cylinder with a pressure chamber which is able to be selectively connected to the coupling connection of the at least one docking station or to the supply line by means of a valve arrangement.

4. The changing device as claimed in claim 1, wherein the coupling connection is able to be connected to the supply line directly by means of a valve arrangement.

5. The changing device as claimed in claim 1, wherein at least two docking units are present.

6. The changing device as claimed in claim 5, wherein, for each reservoir two connections and two docking units are present, the first docking unit of which interacts with one of the connections for each reservoir, and the second docking unit of which interacts with the other one of the connections for each reservoir.

7. A coating system for coating objects, comprising:
a) an application device;
b) a supply system with at least one supply line, via which a liquid medium is able to be supplied to the application device,
wherein
c) the supply system comprises at least one changing device for media as claimed in claim 1.

8. The coating system as claimed in claim 7, wherein at least one section of the supply line is pigged.

9. The coating system as claimed in claim 7, wherein the supply line is connected at an end which is remote from the changing device to a supply container from which the application device can be fed.

10. The coating system as claimed in claim 9, wherein the supply container is a piston dosing device.

11. The coating system as claimed in claim 7, wherein the supply system comprises a distributor via which the application device can be fed from a first supply strand or a second supply strand, wherein each supply strand comprises a separate supply line, and all further components are separately present at the first supply strand and at the second supply strand.
